(19) United States
(12) Patent Application Publication
(10) Pub. No.: US 2005/0091601 A1
(43) Pub. Date: Apr. 28, 2005

(54) Interaction design system

(76) Inventors: Michelle A. Raymond, Minneapolis, MN (US); Todd P. Carpenter, St. Paul, MN (US); Christopher A. Miller, St. Paul, MN (US); Dal Vernon C. Reising, Woodbury, MN (US); Liana-Maria Kiff, Minnetonka, MN (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/507,024

(22) PCT Filed: Mar. 6, 2003
(86) PCT No.: PCT/US03/06853

Related U.S. Application Data
(60) Provisional application No. 60/362,507, filed on Mar. 7, 2002.

(51) Int. Cl. G06F 3/00; G06F 15/00

(52) U.S. Cl. 715/762; 715/513

(57) ABSTRACT

An interaction design system (12) may be used by a designer to design a user interface. The designer supplies the interaction design system with a domain model (22) that contains information characterizing an application in a domain, a user model (24) that contains information characterizing the users of the user interface, a task model (26) that contains task primitives to be performed between the user and the user interface and the type of information required by the task primitives, and a device model (28) that contains information characterizing the interaction delivery devices that are available to deliver the user interface. The interaction design system (10) then matches the interaction delivery devices in the device model (28) to the type of information required by the task primitives and to the information characterizing the users, matches presentation objects (30) to the task primitives and to the information of the domain model (22), and generates the user interface based on the matches (32).

### RELATED APPLICATIONS

This application claims the benefit of U.S. Provisional Application 60/362,507 filed Mar. 7, 2002.

### TECHNICAL FIELD OF THE INVENTION

The present invention relates to an interactive system that is useful in aiding a designer to design and generate user interfaces. For example, the interactive system is useful in aiding the designer to design and generate user interfaces for multiple devices (e.g., cellular telephones, internet browsers, personal digital assistants).

### BACKGROUND OF THE INVENTION

Many tools have been created to aid a human in the design of products. For example, computer aided design (CAD), computer aided engineering (CAE), and computer aided manufacturing (CAM) systems have been developed to assist humans in the design and manufacture of various products. These tools, however, are not easily adaptable to a changing environment. That is, changing technologies relative to the products that can be designed by these tools soon make these tools obsolete. These tools also are not flexible. That is, each of these tools is typically limited to a specific domain to which it applies and does not accommodate other domains. For example, many CAD systems that aid a designer in the design of integrated circuits do not also aid a designer in the design of automobile engines. Moreover, these tools provide at most only a limited capability of designing an interface between the product or system being deigned and the user of that product or system.

Accordingly, there is an interest in developing a design tool that can assist humans in the design of user interfaces in a more complex environment. Such a design tool should not be limited in the domains to which it applies or in the user interfaces that can be provided as an output of the design tool. Thus, the design tool, for example, should permit the design of user interfaces based on (i) the domains within which the user interface is to be used, (ii) the tasks that users will want to perform with respect to the user interface, (iii) the interaction delivery devices that can be used for the delivery of the user interface to the users, (iv) the roles, preferences, and limitations of the user or users who are to use the user interfaces, and/or (v) the presentation elements (i.e., display objects) to be used to display input/output information to the user or users during use of the user interface being designed.

Existing design tools do not integrate these domain, task, available interaction delivery device, user, and presentation element considerations into a flexible interactive design tool that provides a comprehensive approach to information presentation and interaction, that enables the designer to quickly obtain and process information in a wide variety of environments and across a wide variety of tasks, that enables a designer to select from a variety of interaction delivery devices to accomplish tasks, that increases consistency and accuracy of the integration and dissemination of information by the use of common models, that accommodates changing equipment needs, and/or that provides user specific, device appropriate interactions. Moreover, existing design tools do not perform any reasoning with regard to the domain, task, interaction delivery device, user, and/or the presentation element considerations discussed above.

The present invention overcomes one or more of these or other problems.

### SUMMARY OF THE INVENTION

In accordance with one aspect of the present invention, a method of interactively designing a user interface comprises the following: receiving a domain model, a user model, a task model, and a device model, wherein the domain model characterizes an application for which the user interface is to be used, wherein the user model characterizes users who are to interface with the user interface, wherein the task model characterizes tasks to be performed between the user interface and the users, and wherein the device model characterizes interaction delivery devices that are available to deliver the user interface; and, matching characteristics in the domain model, the user model, the task model, and the device model so as to construct the user interface.

In accordance with another aspect of the present invention, a method of interactively designing a user interface comprises the following: creating a domain model, wherein the domain model contains information characterizing a designer selected application in a designer selected domain; creating a user model, wherein the user model contains information characterizing users of the user interface; creating a task model, wherein the task model contains task primitives to be performed between the user and the user interface, and wherein the task model also contains types of information required by the task primitives; creating a device model, wherein the device model contains information characterizing interaction delivery devices that are available to deliver the user interface; and, matching the information contained in the domain model, the user model, and the task model to the information contained in the device model and to presentation elements contained in a presentation elements so as to construct the user interface, wherein the presentation elements comprise objects of the user interface that present information to the user.

In accordance with still another aspect of the present invention, a method of interactively designing a user interface comprises the following: storing a domain model in a computer readable memory, wherein the domain model contains information characterizing data, concepts, and relations of an application in a domain as specified by a designer; storing a user model in the computer readable memory, wherein the user model contains information characterizing roles and preferences of users of the user interface; storing a task model in the computer readable memory, wherein the task model contains task primitives to be performed between the user and the user interface, information required of the task primitives, and sequences of the task primitives; storing a device model in the computer readable memory, wherein the device model contains information including modality characterizing interaction delivery devices that are available to deliver the user interface; matching the interaction delivery devices in the device model to the information required of the task primitives and to the information characterizing the users so as to identify interaction delivery devices that support the information requirements and the users; matching presentation elements to the task primitives and to the data, concepts, and relations of the domain model so as to identify ones of the presentation elements that support the task primitives and the data, concepts, and relations of the domain model; and, generating the user interface based on the identified interaction delivery device and the identified presentation elements.

In accordance with yet another aspect of the present invention, a method of interactively designing a system comprises the following: storing a domain model, a user model, a task model, and a device model in a computer readable memory, wherein the domain model characterizes an application for which the system is to be used, wherein the user model characterizes a user who is to use the system, wherein the task model characterizes tasks to be performed between the system and the user, and wherein the device model characterizes devices to support the system; and, matching characteristics in the domain model, the user model, the task model, and the device model so as to construct the system.

### BRIEF DESCRIPTION OF THE DRAWINGS

These and other features and advantages will become more apparent from a detailed consideration of the invention when taken in conjunction with the drawings in which:

FIG. 1 illustrates a computer useful in implementing an interaction design system according to an embodiment of the present invention;

FIG. 2 illustrates the architecture of the interaction design system according to an embodiment of the present invention; and,

FIGS. 3A and 3B illustrate a flow chart of a program that can be used for the reasoning engine of FIG. 2.

### DETAILED DESCRIPTION

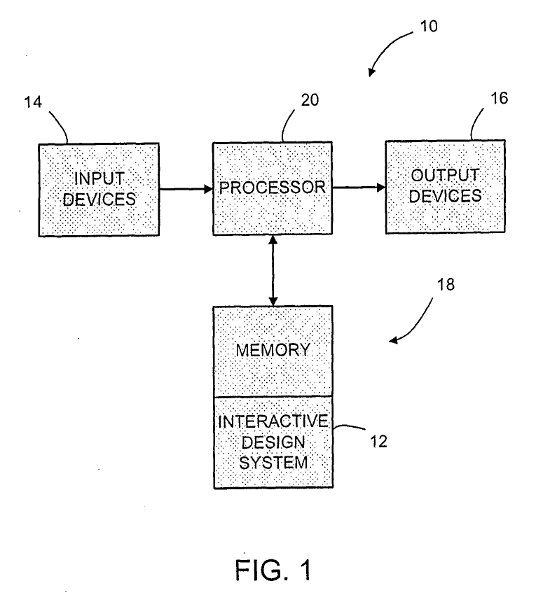

FIG. 1 illustrates a computer 10 that can be used to implement an interaction design system 12 according to one embodiment of the present invention. As shown in FIG. 1, the computer 10 includes one or more input devices 14 such as a keyboard, a mouse, and/or a modem that can be used by a designer to provide the various inputs required by the interaction design system 12 for the design and generation of user interfaces. For example, the designer can use a keyboard of the input devices 14 in providing these inputs to the interaction design system 12 residing on the computer 10. Alternatively, one or more of these inputs can be generated remotely and supplied to the interaction design system 12 residing on the computer 10 through a modem of the input devices 14. As a further alternative, the designer can create the models and/or library discussed below on any suitable machine, save the models and/or library that the designer has created on a memory device, and load the contents of the memory device into the computer 10 at the appropriate time.

The computer 10 includes one or more output devices 16 such as a printer, a display, and a modem that can be used by the designer in interacting with the interaction design system 12 executing on the computer 10. A common modem may be used as one of the input devices 14 and one of the output devices 16. The user interfaces designed and generated by the interaction design system 12 executing on the computer 10 can be provided to the designer as files in XML that the designer or others can then load on the interaction delivery devices selected by the interaction design system 12 to deliver (display visually, audibly, and/or otherwise) the user interfaces to the users.

The computer 10 also includes a memory 18 which may be in the form of random access memory, such as a floppy disk drive and/or a hard disk drive, and read only memory. The memory 18 stores the interaction design system 12 that is executed by the computer 10 to design and generate user interfaces, and may be used by the interaction design system 12 during its execution. The memory 18 may further be used to store the various inputs (models and library) that may be created by the designer and that are used by the interaction design system 12 during its execution to design and generate user interfaces.

Finally, the computer 10 includes a processor 20 that executes the interaction design system 12 stored by the memory 18.

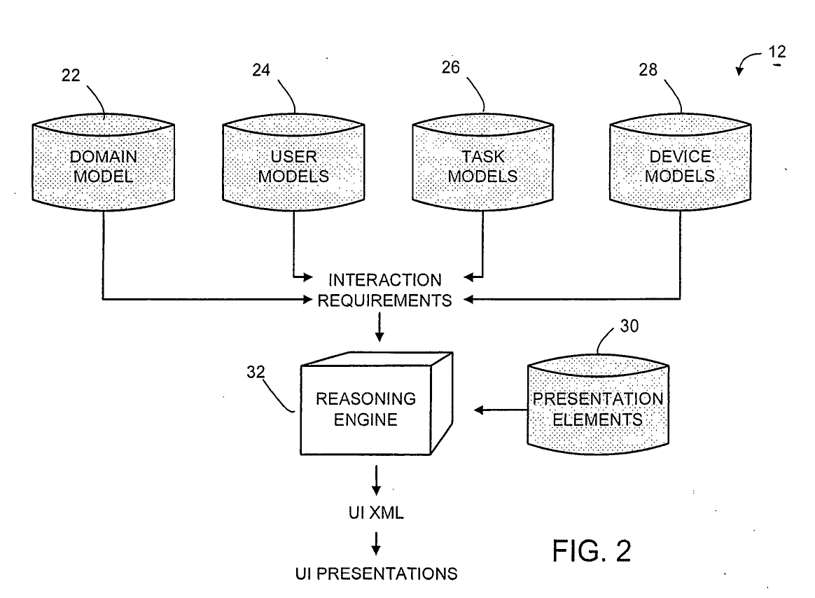

FIG. 2 illustrates the architecture of the interaction design system 12. The interaction design system 12 includes various inputs that the interaction design system 12 uses in designing and generating user interfaces. These inputs include a domain model 22, user models 24, task models 26, and device models 28. In addition, the interaction design system 12 includes a presentation elements library 30 that stores various presentation elements (objects) and a set of characteristics for each presentation element. The characteristics for each presentation element can be matched to the inputs created by the designer to allow a reasoning engine 32 of the interaction design system 12 to make qualitative judgments about the ability of the corresponding presentation elements of the presentation elements library 30 and the interaction delivery devices of the device models 28 to support the performance of the various interactions required of the user interfaces and the input and output of the information required by these interactions.

Thus, the reasoning engine 32 of the interaction design system 12 makes qualitative judgments about the ability of the presentation elements stored in the presentation element library 30 and the interaction delivery devices of the device models 28 (i) to support the application and domain specified by the designer in the domain model 22, (ii) to interact with the users as defined by the designer in the user models 24, (iii) to support the task primitives (i.e., the actions performed between the user interface and the users) as specified by the designer in the task models 26, and (iv) the information required by the task primitives as specified by the designer in the task models 26.

As indicated above, the designer creates the domain model 22 as an input of the interaction design system 12. More specifically, the designer creates the domain model 22 as a machine interpretable domain-specific representation of the relevant domain attributes to be given to a user interface. These attributes include the data, information, concepts, and/or relations pertinent to the application and domain for which the user interface is being designed. The form of the domain representation should be consistent with the other models that are created as inputs so that the interaction design system 12 can properly match the characteristics and specifications of the interaction delivery devices of the device models 28 and of the presentation elements of the presentation elements library 30 with the characteristics and specifications provided in the domain model 22, the user models 24, and the task models 26. The domain model 22 should be application and domain specific.

In creating the domain model 22, the designer will already have in mind a particular application in a particular domain. For example, the designer may wish to design and generate user interfaces for the application of prescription drug ordering and filling in the domain of medicine. The designer must then model the data, information, concepts, and/or relations for this application. For example, in the application of prescription drug ordering and filling, the designer may determine that the user interfaces will deal with various items of information such as doctors, patients, pharmacists, medications, amounts, length of character strings required for the display of each of these entities, etc., with the relationships between these various entities.

The domain model 22 may be hierarchical having, for example, three levels in the hierarchy with domain being the top level, domain elements being the next level down, and domain data being the bottom level. In the prescription drug ordering and filling example, the domain is prescription drug ordering and filling, the domain elements are doctors, patients, care givers, etc, and the domain data are amounts/values, labels/names, times such as pick-up times, lengths of character strings, etc.

In developing the domain model 22, the designer, for example, develops a meta-ontology that specifies the general required structure and vocabulary of the knowledge characterizing the designated domain, designs a specific schema for the selected application of the user interfaces being designed, and then populates the schema with the specific information, relationships; and concepts pertinent to this schema. The Resource Description Framework (RDF) notation may be used to create the schema and to populate it, although any other schema specific notation may be used for these purposes. Appendix A discloses an exemplary class hierarchy that may structure a domain-independent architecture for such a framework.

The RDF Specification is described in the documents “Resouce Description Framework (RDF) Model and Syntax Specification: W3C Recommendation 22 Feb. 1999”, and “RDF/XML Syntax Specification (Revised): W3C Working Draft 23 Jan. 2003”, both herein incorporated by reference. The domain model 22 created by the designer is stored in the memory 18 so that it is available to the interaction design system 12 during its execution on the computer 10.

The following is an abbreviated example of an RDF schema for the domain model 22 in the prescription drug ordering and filling application:

<rdfs:Class rdf:about = “Presciption”/>
<rdfs:Class rdf:about = “Medication”/>
<rdfs:Class rdf:about = “Pharmacy”/>
<rdf:Property rdf:about = “specifiesMedication”/>

<rdfs:domain rdf:resource = “Presciption”/>
<rdfs:range rdf:about = “Medication”/>

<rdf:Property>
<rdf:Property rdf:about = “soldBy”/>

<rdfs:domain rdf:resource = “Medication”/>
<rdfs:range rdf:resource = “Pharmacy”/>

<rdf:Property>

As can be seen, this RDF schema is only a partial schema for the prescription drug ordering and filling application and should be expanded to include the other domain elements and domain data for a practical domain model.

In the user models 24 created by the designer, the designer captures the preferences, roles, and abilities (or limitations) of the users who are identified by the designer as the users of the user interfaces being designed. The preferences, roles, and abilities of the users can be captured using a flexible notation such as RDF. The preferences, roles, and abilities of the users include, for example, role descriptions, interaction delivery device preferences, modality (such as visual or audible) preferences, physical challenges that may confront the users of the user interface being designed, etc. Accordingly, the designer has the responsibility to understand the users and the application requirements so that the designer can create the user models 24 so that they define the relationships between the users and the application.

In the prescription drug ordering and filling example above, the users of the prescription drug ordering and filling interfaces may be any one or more of the following: doctors, patients, care givers, those who may be designated by the patients to pick up the prescribed medicines, etc. The designer should keep in mind the preferences and abilities as well as the roles of all of these people in creating the user models 24. The user models 24 created by the designer are stored in the memory 18 so that they are available to the interaction design system 12 during its execution on the computer 10.

The following is an abbreviated example of an RDF schema for the user models 24 in the prescription drug ordering and filling application:

<rdfs:Class rdf:about=“Person”/>
<rdfs:Class rdf:about=“PhysicalAbilities”/>
<rdfs:Class rdf:about=“VisualAcuity”>

<rdfs:subClassOf rdf:resource=“PhysicalAbilities”/>

</rdfs:Class>
<rdf:Property rdf:about=“VisualRating”>

<rdfs:domain rdf:resource=“VisualAcuity”/>
<rdfs:range rdf:resource=“Literal”/>
<allowedValues>0</allowedValues>
<allowedValues>1</allowedValues>
<allowedValues>2</allowedValues>

<rdf:Property rdf:about=“vision”>

<rdfs:domain rdf:resource=“Person”/>
<rdfs:range rdf:resource=“VisualAcuity”/>

</rdf:Property>

As can be seen, this RDF schema is only a partial schema for the prescription drug ordering and filling application and should be expanded to include other preferences, roles, and abilities of the users who are to use the interfaces being designed.

In creating the task models 26, the designer captures the actions to be performed by the users when using the user interfaces being designed, the goals to be achieved by the user when using the user interfaces being designed, and the information required to perform the actions and achieve the goals. The task models 26 are meant to capture what actions on the part of the user the interfaces are intended to afford or support. The tasks can be captured using a flexible notation such as RDF that includes order-of-flow, nouns (i.e., the information required by the tasks), and the tasks that are to be performed. Accordingly, the designer has the responsibility to understand the task requirements within the application and to apply the modeling notation to capture the specific task requirements.

In task modeling, the designer decomposes each task or interaction to be performed by the user into task primitives, an order to flow from each task primitive, and the type of information required by the task primitive. The task primitives may include any actions that a designer is likely to require between users and user interfaces for the relevant application in the relevant domain. For example, task primitives may include receive, instantiate, compare, monitor, assert, select, control, retract, change, detect, direct attention, navigate, adjust, etc. View, listen, review, and assess may be synonyms of the task primitive receive. Configure may be a synonym of instantiate. Observe and watch may be synonyms of the task primitive monitor. Set, enter, input, record, and declare may be synonyms of the task primitive assert. Pick and select-item-from-set may be synonyms of the task primitive select. Maintain, direct, and command may be synonyms of the task primitive control. Undo and withdraw may be synonyms of the task primitive retract. Modify, update, edit, and alter may be synonyms of the task primitive change. Identify, catch, and notice may be synonyms of the task primitive detect. Focus may be a synonym of the task primitive direct attention. Move may be a synonym of the task primitive navigate. Configure may be a synonym of the task primitive adjust.

Also, as indicated above, the designer captures order-of-flow. Order-of-flow refers to the precedence between task primitives, and can be designated by junctions and links in the notation applied to the task models 26. Such junctions may include, for example, AND, OR, and XOR junctions that may be synchronous or asynchronous. Links, for example, may be used to indicate that action B does not start before action A completes, that action A must be followed by action B, that action B must be preceded by action A, that actions A and B are both required, etc.

Moreover, the task models 26 also include the information required by the task primitives of the tasks being modeled. For example, the task primitive receive requires that information be received by the user. The designer defines the type of information for this task primitive in the task models 26. As another example, the task primitive instantiate requires that information be instantiated. The designer defines the type of information for this task primitive instantiation in the task models 26. As still another example, the task primitive compare requires that certain information be compared to certain other information. The designer defines the type of information for this task primitive compare in the task models 26. The other task primitives also require information typing, and the designer defines the type of information for each of these task primitives that is used in the task models 26 as well. The task models 26 created by the designer are stored in the memory 18 so that they are is available to the interaction design system 12 during its execution on the computer 10.

In the prescription drug ordering and filling example above, the tasks to be performed may include directing the user to choose from among a displayed set of pharmacies, to choose whether the prescription is a refill, to designate a person to pick up the medication, to indicate that the prescription is to be moved from one pharmacy to another, etc.

The following is an abbreviated example of an RDF document adhering to the IDS RDF Schema for the task modeling 26 in the prescription drug ordering and filling application:

<userTask rdf:about=“idsTask_00025”

identifier=“tskFillPrescription”
name=“Fill Prescription”
primitive=“NONPRIMITIVE”
rdfs:label=“tskFillPrescription”>
<tasks rdf:resource=“idsTask_00026”/>
<entryTask rdf:resource=“idsTask_00026”/>
<tasks rdf:resource=“idsTask_00027”/>
<tasks rdf:resource=“idsTask_00028”/>
<exitTask rdf:resource=“idsTask_00029”/>
<tasks rdf:resource=“idsTask_00029”/>
<tasks rdf:resource=“idsTask_00032”/>
<matchRequirements rdf:resource=“idsTask_00036”/>

</userTask>
<junction rdf:about=“idsTask_00026”

identifier=“AND1”
operator=“AND”
primitive=“JUNCTION”
rdfs:label=“AND1”>
<parent rdf:resource=“idsTask_00025”/>
<mate rdf:resource=“idsTask_00029”/>
<followingRelations rdf:resource=“idsTask_00030”/>
<followingRelations rdf:resource=“idsTask_00034”/>

</junction>
<userTask rdf:about=“idsTask_00027”

classElement=“medication”
identifier=“tskSelectMedication”
name=“Select Medication”
primitive=“SELECT”
rdfs:label=“tskSelectMedication”>
<parent rdf:resource=“idsTask_00025”/>
<precedingRelations rdf:resource=“idsTask_00030”/>
<followingRelations rdf:resource=“idsTask_00031”/>
<matchRequirements rdf:resource=“idsTask_00036”/>

</userTask>
. . .
<relation rdf:about=“idsTask_00030”

identifier=“relation1”
relationship=“PRECEDENCE”
rdfs:label=“relation1”>
<source rdf:resource=“idsTask_00026”/>
<destination rdf:resource=“idsTask_00027”/>

</relation>

As can be seen, this RDF document is only a partial example for the prescription drug ordering and filling application and should be expanded to include other tasks to be performed by the users when using the interfaces being designed.

In the device models 28, the designer captures the specifications and characteristics of the interaction delivery devices that are available to deliver the user interfaces being designed when these user interfaces are invoked by the applications for which they are designed. These specifications should include the capabilities and modalities that are supported by the available interaction delivery devices and that are relevant to the application. The capabilities, for example, may include bandwidth, memory, screen, lines of display, width of display, illumination, etc., and the modalities, for example, may include visual, audible, etc.

These specifications and characteristics of the interaction delivery devices can be captured using a flexible notation such as RDF that includes a mechanism to describe an interaction delivery device's specific input and output modalities and capabilities. The designer has the responsibility to understand the interaction delivery device specification and to apply the interaction delivery device description notation to produce the device models 28. The device models 28 created by the designer are stored in the memory 18 so that they are available to the interaction design system 12 during its execution on the computer 10.

In the prescription drug ordering and filling example above, interaction delivery devices can include web browsers, personal digital assistants, telephonic interaction delivery devices, etc. These interaction delivery devices are existing interaction delivery devices that can be used to deliver the user interface to the users. In the case of audio interaction delivery devices, the capabilities of such interaction delivery devices can include number of tones, word rate, speech vs. tone only, etc. In the case of visual interaction delivery devices, the capabilities of such interaction delivery devices can include number of lines, number of characters per line, update rate, etc. In the case of hardware buttons, the capabilities can include yes/no/select vs. none, numeric vs. none, up/down vs. none, left/right vs. none, alphabetic vs. none, input rate, etc.

The following is an abbreviated example of an RDF schema for the device models 28 in the prescription drug ordering and filling application:

<rdfs:Class rdf:about=“InteractionDevice”>

<rdfs:subClassOf rdf:resource=“DomainItem”/>

</rdfs:Class>
<rdfs:Class rdf:about=“DeviceSignature”>

<rdfs:subClassOf rdf:resource=“NounSignature”>

</rdfs:Class>
<rdfs:Class rdf:about=“AudioDisplayCharacteristics”/>
<rdfs:Class rdf:about=“HardwareButtonCharacteristcs”/>
<rdf:Property rdf:about=“supportedDeviceSignature”>

<rdfs:range rdf:resource=“DeviceSignature”/>
<rdfs:domain rdf:resource=“InteractionDevice”/>

</rdf:Property>
<rdf:Property rdf:about=“audioDisplay”>

<rdfs:range

rdf:resource=“AudioDisplayCharacteristics”/>

<rdfs:domain rdf:resource=“DeviceSignature”/>

</rdf:Property>
<rdf:Property rdf:about=“speechOutput”

ids:range=“boolean”>
<rdfs:domain

rdf:resource=“AudioDisplayCharacteristics”/>

<rdfs:range rdf:resource=“&rdfs;Literal”/>

</rdf:Property>

As can be seen, this RDF schema is only a partial schema for the description of interaction devices and should be expanded to include other interaction delivery device specifications for the interaction delivery devices that can potentially deliver user interfaces to users.

Presentation elements are the display objects that are used to present information to or acquire information from a user of the user interface being designed. In the context of a web browser being used as the interaction delivery device, a presentation element may be a pop up menu, a pull down menu, a dialog box, a button, etc.

Each of the presentation elements stored in the presentation elements library 30 contains a set of functionality and usability characteristics that the corresponding presentation element either supports or requires for correct application in a presentation. The functionality and usability characteristics describe the quality of the interaction that can be achieved given the functionality and usability characteristics of the display objects. The functionality and usability characteristics for each presentation element should have a form so that they can be matched by the reasoning engine 32 to the other inputs, and so that the reasoning engine 32 can make qualitative judgments about the ability of the presentation elements to support the input and output of the data to be exchanged between the users and the user interfaces.

In the prescription drug ordering and filling application, examples of presentation elements include pull down menus, dialog boxes, windows, buttons, etc.

The following is an abbreviated example of an XML composer, written in Java, for the presentation elements library 30 in the prescription drug ordering and filling application:

private String createXML(final Presentation

presentation) {

// get the task's name
String taskName = “name=” + “\”“ +

presentation.getInteractionRequirement( ).getTask( ).getName
( ) + “\”” ;

// get the task's identifier
String taskIdentifier = “identifier=” + “\”“ +

presentation.getInteractionRequirement( ).getTask( ).getIdentifier
( ) + “\”” ;

// get the domain element content
output =

presentation.getInteractionRequirement( ).getDomainItem( ).
getContent(presentation.getInteractionRequirement( ).getTask
( ));

// Create outer <textbox> element tags
String preFix = “<textBox ” + taskName + “ ” +

taskIdentifier + “>”;

preFix = preFix + “ <label><text>” +

presentation.getInteractionRequirement( ).getTask( ).getName
( ) + “</text></label>”;

//sandwich content between open and end tags
output = preFix + output + “</textBox>”;
return output;
}

As can be seen, this XML composer is only one example and should be expanded to include other presentation elements that can potentially be used to exchange information between the users and the application for which the user interfaces are being designed.

As shown in FIG. 2, the domain model 22, the user models 24, the task models 26, and the device models 28 combine to define the interaction requirements of the user interface being designed. Each interaction requirement is a combination of a task primitive and information required by the task primitive as influenced by the characteristics of the users and the application and domain for which the user interface is being designed. Thus, a user interface typically involves a plurality of interaction requirements that define the totality of the way in which the users interact with the user interface being defined.

The domain model 22, the user models 24, the task models 26, the device models 28, and the presentation elements library 30 are stored in the memory 18 in preparation for the execution of the reasoning engine 32. Based on the domain model 22, the user models 24, the task models 26, the device models 28, and the presentation elements library 30, the reasoning engine 32 makes qualitative judgments about the best fit between the presentation elements and the interaction delivery devices in order to interact with the user through the user interface as intended by the designer.

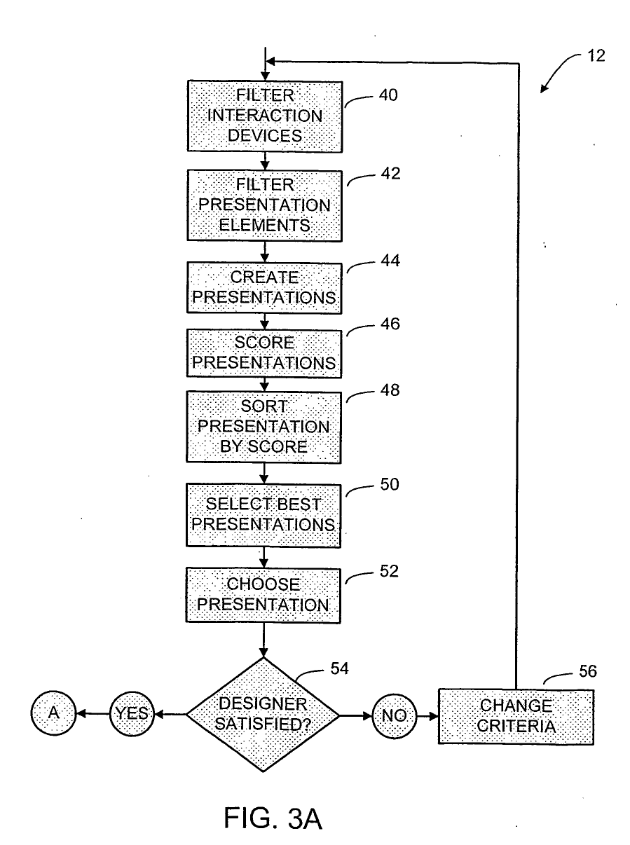

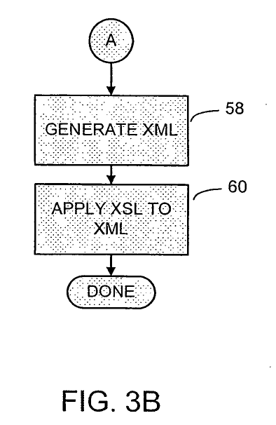

A flow chart of a program that can be used for the reasoning engine 32 is shown in FIGS. 3A and 3B. Once the domain model 22, the user models 24, the task models 26, the device models 28 have been created and entered by the designer and stored in the memory 18, and once the presentation elements library 30 has been populated with the presentation elements, the reasoning engine 32 may be executed.

Accordingly, a block 40 filters the interaction delivery devices of the device models 28 based on the information requirements of the task primitives defined in the tasks models 26 and the roles, preferences, and abilities of the users as defined in the user models 24 so as to form an intersection between these available interaction delivery devices, information requirements, and user characteristics. Accordingly, the information requirements of the task primitives as modeled by the designer in the tasks models 26, the roles, preferences, and abilities of the users as modeled by the designer in the user models 24, and the characteristic specifications and capabilities of the interaction delivery devices as modeled by the designer in the device models 28 are matched, and only those available interaction delivery devices that can support those information requirements and user characteristics are saved for further processing. These saved interaction delivery devices, therefore, are the filtered output of the filtering process of the block 40.

As an example, if a user is to invoke an interface to change the temperature of a room, the block 40 of the interaction design system 12 should consider those interaction delivery devices that are available to change temperatures and that meet the preferences, roles and abilities of the intended users.

A block 42 filters the presentation elements stored in the presentation library 30 based on the task primitives of the task models 26 and the characteristics of the information, concepts, and relations of the domain model 22 to form an intersection between the presentation elements stored in the presentation library 30, the task primitives of the task models 26, and the domain characteristics of the domain model 22. Accordingly, the presentation elements, the task primitives, and the domain characteristics are matched, and only those presentation elements that can support the task primitives and domain characteristics are saved for further processing. These saved presentation elements, therefore, are the output of the filtering process of the block 42.

As an example, if a task is a SELECT primitive, and the user is supposed to select a numeric value as a domain characteristic, the block 42 considers those presentation elements that support SELECT of numeric lists.

A block 44 creates a presentation comprising each presentation element saved as a result of the processing of the block 42 and the interaction delivery devices that are saved as a result of the processing of the block 40 and that support the corresponding presentation element. Accordingly, the block 44 matches the interaction delivery devices saved by the block 40 and the presentation elements saved by the block 42, and creates a presentation for each saved presentation element and matching interaction delivery device.

It should be understood that each presentation element is not required to support all of the interaction delivery devices. Similarly, each interaction delivery device is not required to support all presentation elements. However, it is quite possible that any given presentation element saved by the block 42 will match more than one of the interaction delivery devices saved by the block 40. Therefore, a presentation element may be included in more than one presentation. Each presentation comprises a presentation element and an interaction delivery device as a matching pair. The presentations at the output of the block 44 form a fully-resolved set of usability or interaction capabilities.

A block 46 assigns a score to each presentation based on the quality of the match that produced the interaction delivery devices saved by the block 40 and the quality of the match that produced the presentation elements saved by the block 42. This scoring is a qualitative judgment about how well a presentation (presentation element/interactive deliver device pair) meets the domain characteristics of the domain model 22, the roles, preferences, and abilities of the users as defined in the user models 24, and the task primitives and corresponding information requirements defined in the task models 26.

For example, if a presentation element is to perform the task primitive receive in order to display information such as current temperature to a user, various presentation elements, such as a digital readout, a round graphic, and a thermostat graphic, can be considered. Each of these presentation elements may be assigned a set of values such as DisplayScope (DS), DisplayResolution (DR), DisplayBandwidth, DisplayBandwidth (DB), DisplayImportance (DI), DispalyObtrusiveness (DO), ControlScope (CS), ControlResolution (CR), ControlBandwidth (CB), and/or ControlImportance (CI) that describe the characteristics of the presentation element. Similarly, the information requirement of this presentation element may also be assigned a set of values such as DisplayScope (DS), DisplayResolution (DR), DisplayBandwidth, DisplayBandwidth (DB), DisplayImportance (DI), DispalyObtrusiveness (DO), ControlScope (CS), ControlResolution (CR), ControlBandwidth (CB), and/or ControlImportance (CI) that describe the characteristics of the presentation element. Some presentation elements are essentially only displays, showing information, (hence the use of the word “display”). Other presentation elements allow for inputs or manipulations (hence the use of the word “control”). Still other presentation elements might be both a display and a control. In any case, a set of values DS-CI need to be assigned to the presentation elements so that the reasoner of FIGS. 3A and 3B can reason. These values may be compared, and a score can be generated that indicates how closely the values of the information requirement and the presentation element match. The block 46 uses these scores for the corresponding presentations. It is also possible to generate a similar score for each interaction delivery device that indicates how closely the characteristics of the interaction delivery devices match the characteristics stored in the user models 24 and the tasks models 26. The block 46 may be arranged to combine the presentation element score and the interaction delivery device score to form a composite score for the corresponding presentation.

A block 48 then sorts the presentations by score. For each interaction requirement of the user interface being designed as defined by the domain model 22, the user models 24, the task models 26, and the device models 28, a block 50 selects the presentations having the best scores. For each such interaction requirement, a block 52 chooses a presentation off of the best score list. If the designer is not satisfied with the collection of presentations as indicated by a block 54, the designer may change the characteristics and/or requirements of one or more of the models at a block 56 until the designer is satisfied with the resulting user interface. Alternatively or additionally, the designer may cause the interaction design system 12 to choose a different combination of presentations at the block 52. Accordingly, the design of a user interface is an iterative process between the designer and the interaction design system 12, and this process continues until the designer is satisfied with the designed user interface.

A block 58 generates the presentations as an XML file, and a block 60 applies the interaction delivery devices' XSL to the XML generated by the block 58. It is noted that the result of the block 60 does not include the necessary application-specific communications between the chosen interaction delivery device and the application for which the user interface is being designed. Rather, the result of the block 60 is the interaction appropriate for the interaction delivery device once an appropriate application makes the user interface available to the user.

The device models 28 and the presentation elements library 30 may remain unchanged from user interface design to user interface design. On the other hand, the designer may change the device models 28 and/or the presentation elements library 30 in preparation for the design of one or more user interfaces. The domain model 22, the user models 24, and/or the task models 26 will likely, although not necessarily, change from design to design. One of the advantages of the interaction design system 12 is that it can adapt to new domains, to new applications, to new tasks, to new interaction delivery devices, to new presentation elements, and to new user requirements simply by storing the appropriate information in the domain model 22, the user models 24, the task models 26, the device models 28, and/or the presentation elements library 30.

Certain modifications of the present invention have been described above. Other modifications will occur to those practicing in the art of the present invention. For example, although the present invention is specifically described above in terms of designing and generating user interfaces, the present invention may be adapted to aiding a designer in the design and generation of products, systems, machines, and arrangements other than user interfaces.

Also, the flow chart of FIGS. 3A and 3B is described above (particularly with respect to blocks 40-56) as generating all presentations for all interaction requirements prior to generation of the XML file. Instead, a presentation can be added to the XML file one interaction requirement at a time until all interaction requirements are designed into the user interface

Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

1. A method of interactively designing a user interface comprising:
receiving a domain model, a user model, a task model, and a device model, wherein the domain model characterizes an application for which the user interface is to be used, wherein the user model characterizes users who are to interface with the user interface, wherein the task model characterizes tasks to be performed between the user interface and the users, and wherein the device model characterizes interaction delivery devices that are available to deliver the user interface; and,
matching characteristics in the domain model, the user model, the task model, and the device model so as to construct the user interface.

2. The method of claim 1 wherein the matching of characteristics comprises forming an intersection between the domain model, the user model, the task model, and the device model.

3. The method of claim 1 wherein the matching of characteristics comprises:
matching the interaction delivery devices to information requirements defined in the tasks model and to the users defined in the user models to identify interaction delivery devices that support the information requirements and the users; and,
matching presentation elements to task primitives of the task model and to characteristics provided in the domain model to identify presentation elements that support the task primitives and the domain characteristics, wherein the presentation elements comprise display objects.

4. The method of claim 3 wherein the matching of characteristics comprises creating a presentation for each identified presentation element and a matching one of the identified interaction delivery devices.

5. The method of claim 4 wherein the matching of characteristics comprises scoring and sorting the presentations, and wherein the matching of characteristics comprises selecting the presentations having the best scores.

6. The method of claim 5 wherein the matching of characteristics comprises generating the user interface based on the selected presentations.

7. The method of claim 5 wherein the selecting of the presentations comprises selecting the presentations having the best scores for all interactions between the users and the user interface.

8. The method of claim 7 wherein the matching of characteristics comprises generating the user interface based on the selected presentations.

9. The method of claim 4 wherein the matching of characteristics comprises generating the user interface based on the presentations.

10. A method of interactively designing a user interface comprising:
creating a domain model, wherein the domain model contains information characterizing a designer selected application in a designed selected domain;
creating a user model, wherein the user model contains information characterizing users of the user interface;
creating a task model, wherein the task model contains task primitives to be performed between the user and the user interface, and wherein the task model also contains types of information required by the task primitives;
creating a device model, wherein the device model contains information characterizing interaction delivery devices that are available to deliver the user interface; and,
matching the information contained in the domain model, the user model, and the task model to the information contained in the device model and to presentation elements contained in a presentation elements so as to construct the user interface, wherein the presentation elements comprise objects of the user interface that present information to the user.

11. The method of claim 10 wherein the domain model, the user model, the task model, and the device model are created using a consistent notation.

12. The method of claim 11 wherein the notation adheres to the Resource Description Framework specification or other specific knowledge technology notations.

13. The method of claim 10 wherein the domain model, the user model, the task model, and the device model are stored in a computer readable memory.

14. The method of claim 10 wherein the matching of the information comprises forming an intersection between the presentation elements and the information contained in the domain model, the user model, the task model, the device model, and the presentation elements library.

15. The method of claim 10 wherein the
matching of the information comprises: matching the interaction delivery devices to the type of information required of the task primitives and to the information characterizing the users so as to identify interaction delivery devices that support the information requirements and the users; and,
matching the presentation elements to the task primitives and to the information characterizing the designer selected application in the designer selected domain so as to identify presentation elements that support the task primitives and the domain information.

16. The method of claim 15 wherein the matching of the information comprises creating a presentation for each identified presentation element that matches at least one of the identified interaction delivery devices.

17. The method of claim 16 wherein the matching of the information comprises scoring and sorting the presentations, and wherein the matching of the information comprises selecting the presentations having the best scores.

18. The method of claim 17 wherein the matching of the information comprises generating the user interface based on the selected presentations.

19. The method of claim 17 wherein the selecting of the presentations comprises selecting the presentations having the best scores for all interactions to be performed by the user interface.

20. The method of claim 19 wherein the matching of the information comprises generating the user interface based on the selected presentations.

21. The method of claim 10 wherein the domain model, the user model, the task model, and the device model are created using a consistent notation, and wherein the matching of the information comprises:
matching the interaction delivery devices to the information required of the task primitives and to the information characterizing the users so as to identify interaction delivery devices that support the information requirements and the users; and,
matching the presentation elements to the task primitives and to the information characterizing a specific application in a specific domain so as to identify presentation elements that support the task primitives and the domain information.

22. The method of claim 21 wherein the matching of the information comprises creating presentations, and wherein each presentation comprises a matching pair of one of the presentation elements and one of the interaction delivery devices.

23. The method of claim 22 wherein the matching of characteristics comprises selecting one of the presentations for each interaction to be performed between the user interface and the users.

24. A method of interactively designing a user interface comprising:
storing a domain model in a computer readable memory, wherein the domain model contains information characterizing data, concepts, and relations of an application in a domain as specified by a designer;
storing a user model in the computer readable memory, wherein the user model contains information characterizing roles and preferences of users of the user interface;
storing a task model in the computer readable memory, wherein the task model contains task primitives to be performed between the user and the user interface, type of information required of the task primitives, and sequences of the task primitives;
storing a device model in the computer readable memory, wherein the device model contains information including modality characterizing interaction delivery devices that are available to deliver the user interface;
matching the interaction delivery devices in the device model to the type of information required of the task primitives and to the information characterizing the users so as to identify interaction delivery devices that support the information requirements and the users;
matching presentation elements to the task primitives and to the data, concepts, and relations of the domain model so as to identify ones of the presentation elements that support the task primitives and the data, concepts, and relations of the domain model; and,
generating the user interface based on the identified interaction delivery device and the identified presentation elements.

25. The method of claim 24 wherein the generating of the user interface comprises creating presentations between matching ones of the identified presentation elements and ones of the identified interaction delivery devices.

26. The method of claim 25 wherein the generating of the user interface comprises scoring and sorting the presentations, and wherein the generating of the user interface comprises selecting the presentations having the best scores.

27. The method of claim 26 wherein the generating of the user interface comprises generating the user interface based on the selected presentations.

28. The method of claim 26 wherein the selecting of the presentations comprises selecting the presentations having the best scores for all interactions to be performed by the user interface.

29. The method of claim 28 wherein the generating of the user interface comprises generating the user interface based on the selected presentations.

30. The method of claim 29 further comprising creating the domain model, the user model, the task model, and the device model using a consistent notation.

31. The method of claim 30 wherein the notation adheres to the Resource Description Framework specification or other specific knowledge technology notations.

32. The method of claim 30 wherein the generating of the user interface comprises creating presentations between matching ones of the identified presentation elements and the identified interaction delivery devices.

33. The method of claim 32 wherein the generating of the user interface comprises selecting one of the presentations for each interaction to be performed between the user interface and the users.

34. The method of claim 33 wherein the generating of the user interface comprises generating the user interface based on the selected presentations.

35. The method of claim 24 wherein the generating of the user interface comprises creating presentations between matching ones of the identified presentation elements and the identified interaction delivery devices.

36. The method of claim 35 wherein the generating of the user interface comprises selecting one of the presentations for each interaction to be performed between the user interface and the users.

37. The method of claim 36 wherein the generating of the user interface comprises generating the user interface based on the selected presentations.

38. A method of interactively designing a system comprising:
storing a domain model, a user model, a task model, and a device model in a computer readable memory, wherein the domain model characterizes an application for which the system is to be used, wherein the user model characterizes a user who is to use the system, wherein the task model characterizes tasks to be performed between the system and the user, and wherein the device model characterizes devices to support the system; and,
matching characteristics in the domain model, the user model, the task model, and the device model so as to construct the system.

39. The method of claim 38 wherein the matching of characteristics comprises forming an intersection between the domain model, the user model, the task model, and the device model.

40. The method of claim 39 further comprising creating the domain model, the user model, the task model, and the device model using a consistent notation.

41. The method of claim 40 wherein the notation adheres to the Resource Description Framework specification or other specific knowledge technology notations.
